(19) United States
(12) Patent Application Publication
(10) Pub. No.: US 2021/0332776 A1
(43) Pub. Date: Oct. 28, 2021

(54) ROTARY VAPORIZER

(71) Applicant: ZAMA JAPAN CO. LTD., Iwate (JP)

(72) Inventors: Daisuke Suzuki, Iwate (JP); Takumi Takahashi, Iwate (JP); Naoya Wada, Iwate (JP); Toshiyuki Kuyo, Iwate (JP)

(21) Appl. No.: 17/234,556

(22) Filed: Apr. 19, 2021

(30) Foreign Application Priority Data
Apr. 28, 2020 (JP) 2020-079768

(51) Int. Cl. F02M 9/02; F02M 19/04; F02M 9/08

(52) U.S. Cl. CPC F02M 9/02; F02M 9/08; F02M 19/04

(57) ABSTRACT

Disclosed herein is a rotary vaporizer that solves the problem caused by a conventional throttle valve becoming cantilevered when the throttle wire is pulled. The rotary vaporizer includes: a valve shaft; a measuring needle disposed within the valve shaft; a throttle valve having a lumen to receive the valve shaft; and a support pin having a conical distal end having a predetermined angle. The conical distal end is configured to move axially move the throttle valve by gliding on an angled surface of the throttle valve, and the angled surface is parallel to a surface of the conical distal end.

### CROSS-REFERENCED TO RELATED APPLICATION

The subject application claims the benefit of Japanese Patent Application No. 2020-079768, filed Apr. 28, 2020, which application is incorporated herein by reference in its entirety.

### TECHNICAL FIELD

The disclosure relates generally to a rotary vaporizer with a cam mechanism for moving the throttle valve in the valve axial direction.

### BACKGROUND

The use of conventional rotary throttle valve vaporizers found in two-stroke internal combustion engines has greatly increased as they are essential in portable working machines for agriculture, forestry, and small vehicle. The rotary throttle valve is formed in a rotor that rotates in the axial direction of the valve to supply vaporized fuel to the engine.

A rotary type vaporizer (rotary throttle valve type vaporizer) equipped with a cam mechanism for moving the throttle valve in the valve axial direction is widely used. In this rotary type vaporizer, a columnar throttle valve having a throttle valve hole and a measuring needle is arranged perpendicular to the intake passage of the vaporizer body, and the valve is rotated while rotating the throttle valve according to the accelerator operation. By moving in the axial direction, the air flow rate is controlled while changing the degree of overlap of the throttle valve hole with the intake passage. The fuel flow rate is controlled by changing the insertion depth of the measuring needle into the fuel nozzle.

A cam mechanism is used as a means for moving the throttle valve in the valve axial direction. For example, this type of cam mechanism is described in Japanese Patent Application Laid-Open No. 58-92447, see FIG. 1. The rotary vaporizer shown in FIG. 1 includes a cover body 3a that closes a throttle valve chamber 2a, which is fitted with a throttle valve. As shown, the rotary vaporizer includes a cam 4a and a driven pin 6a that is projected from the lower surface of throttle lever 5a.

This rotary vaporizer has the advantage that it can be installed without increasing the size of the vaporizer body compared to the one with a cam mechanism inside. However, the cam mechanism is exposed to the outside which allows dust to settle and adhere to the mechanism. This tends to cause malfunction and instability of fuel flow rate.

In another example, Japanese Patent Application Laid-Open No. 6-129303 describes a rotary vaporizer (shown in FIG. 2) with a driven pin 6a being projected from the bottom surface of a throttle valve 1a. End face cam 4a is projected from the bottom surface of throttle valve chamber 7a. As shown, this type of a rotary vaporizer with the cam mechanism arranged internally and in the opposite direction is known.

Rotary type vaporizers with internally located cam mechanism (e.g., disposed inside the vaporizer body) are not exposed to dust from the outside. However, more space needs to be provided for installing the cam mechanism inside of the vaporizer body. Since it is necessary to secure it, it can easily be done by increasing the size of the vaporizer body, especially when using a large throttle valve for a large displacement engine. However, increasing the size of the vaporizer body is not suitable for small engines because there is lack of space in small engines.

To solve the above space problem, Japanese Patent Application Laid-Open No. 2011-132945 and Japanese Patent Application Laid-Open No. 10-281007 describe a rotary type vaporizer with a cam mechanism moving the throttle valve in the valve axial direction. This eliminates the need to increase the size of the vaporizer body.

FIGS. 3 and 4 show a rotary type vaporizer as described in JP-A-2011-132945. The rotary type vaporizer shown in FIGS. 3 and 4 has a columnar throttle valve 1 and a measuring needle 2 arranged on the central axis thereof. The inserted fuel nozzle 3 and a cam mechanism 5 are arranged to move throttle valve 1 in the direction of valve shaft 4, which is operated by a throttle wire (not shown) according to a throttle operation. By rotating throttle valve 1, cam mechanism 5 moves in the valve axial direction to adjust the air flow rate and the fuel flow rate. Cam mechanism 5 is attached to the bottom surface 6 of the throttle valve 1. A columnar column defined by cam groove 8 and throttle valve 1 (having cam surface 7) gradually becomes deeper along the rotation direction. The depth of the column has a predetermined range.

Support pin 11 is inserted between bottom surface 10 of throttle valve chamber 9 and cam surface 7 to support throttle valve 1 from bottom surface 6 side. The portion forming cam surface 7 is the throttle, which protrudes from bottom surface 6 of valve 1 or bottom surface 10 of the throttle valve chamber 9. With the width of support pin 11, the length of the throttle valve chamber 9 extends in the direction of valve shaft 4 and the vaporizer. While the size of the main body has been increased, cam surface 7 of cam mechanism 5 is formed by having a recess at bottom surface 6 of throttle valve 1 such that support pin 11 is formed in cam groove 8 (and on cam surface 7). In addition to not protruding into cam groove 8, support pin 11 fits in cam groove 8, so that it is possible to minimize the increase in size of vaporizer body 12.

Further, the rotary vaporizer presented in Japanese Patent Application Laid-Open No. 10-281007 has almost the same overall configuration as the conventional examples shown in FIGS. 3 and 4. However, cam groove 8 constituting cam mechanism 5 is formed on the surface of throttle valve 1 facing the intake passage 14 of flange body 18, which is provided at the shaft side end. Support pin 11 constituting cam mechanism 5 is supported by vaporizer body 12. The points are different, the structure of cam mechanism 5 is simple, which allows throttle valve 1 to be easily assembled, disassembled, and reassembled, and stable air flow rate and fuel flow rate control without dust adhesion.

However, in the above conventional rotary vaporizers, the cam mechanism 5 (which is formed by cam surface 7 of cam groove 8) is formed in a plane oriented in a direction perpendicular to the central axis (not shown) in the vertical direction and is supported. The portion of pin 11 inserted into the cam groove 8 is cylindrical. Thus, when the throttle wire (not shown) is pulled, throttle valve 1 cantilevered due to the positional relationship between the pulling direction of the throttle wire and the cam groove 8. This creates a scenario where the throttle valve becomes tilted, which is undesirable.

As a result of the tilt, throttle valve 1 (particularly the corner portion) comes into contact with the inner wall of throttle valve chamber 9 and causes malfunctions. Additionally, the tilt can cause an increase in the operating force of the throttle (not shown). For example, the throttle does not move linearly, and it takes a long time to return the throttle. And due to the tilt, the throttle may stop in the middle configuration.

### SUMMARY OF THE INVENTION

The present disclosure is intended to solve the above problems by using a new and improved cam mechanism configured to move the throttle valve in the valve axial direction without having to increase the size of the vaporizer body. Additionally, the novel cam mechanism eliminates the cantilevered throttle valve issue when the throttle wire is pulled. In other words, with the new and improved cam mechanism, throttle valve is not cantilevered (e.g., tilted) when the throttle wire is pulled. The improved rotary vaporizer (with the novel cam mechanism) can improve efficiency and productivity by adjusting the air flow and fuel flow to a predetermined target specification by adjusting the insertion depth into the fuel nozzle. In the improved rotary vaporizer, the opening area into the air-fuel mixture passage of the groove pocket does not change (or only changes slightly even when the fuel is increased or decreased) by moving the throttle valve in an axial direction using an adjusting screw in the idle region. Additionally, the groove pocket in the improved rotary vaporizer in designed to overlap the air-fuel mixture passage.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a partial vertical sectional view showing a conventional example.

FIG. 2 is a vertical cross-sectional view of a further different conventional example.

FIG. 3 is a partial vertical cross-sectional view when the throttle valve of the conventional example is fully closed.

FIG. 4 is a vertical cross-sectional view of a portion when the throttle valve of the conventional example shown in FIG. 1.

FIG. 5 illustrates a vertical cross-sectional view of a throttle valve vaporizer in a fully closed position in accordance with some embodiments of the present disclosure.

FIG. 6 illustrates a vertical cross-sectional view of a throttle valve vaporizer in a fully opened position in accordance with some embodiments of the present disclosure.

FIG. 7A illustrates a perspective view of a throttle valve in accordance with some embodiments of the present disclosure.

FIG. 7B illustrates a front view of a throttle valve in accordance with some embodiments of the present disclosure.

FIG. 7C illustrates a side view of a throttle valve in accordance with some embodiments of the present disclosure.

FIG. 8 illustrates a vertical cross-sectional view of a throttle valve vaporizer in accordance with some embodiments of the present disclosure.

FIG. 9 illustrates a support pin in accordance with some embodiments of the present disclosure.

FIG. 10 illustrates a front view of the throttle valve in FIG. 5 in accordance with some embodiments of the present disclosure.

FIG. 11 illustrates a vertical cross-sectional view of a conventional throttle valve vaporizer.

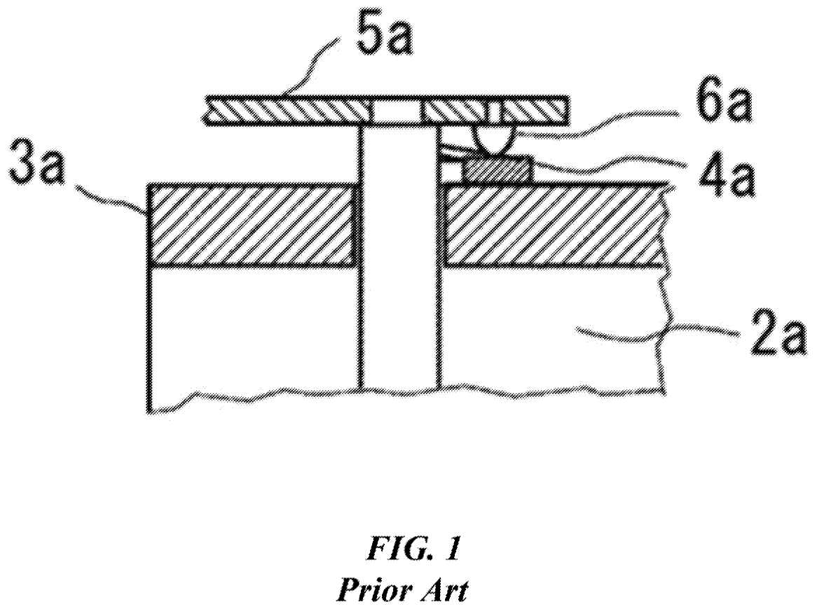

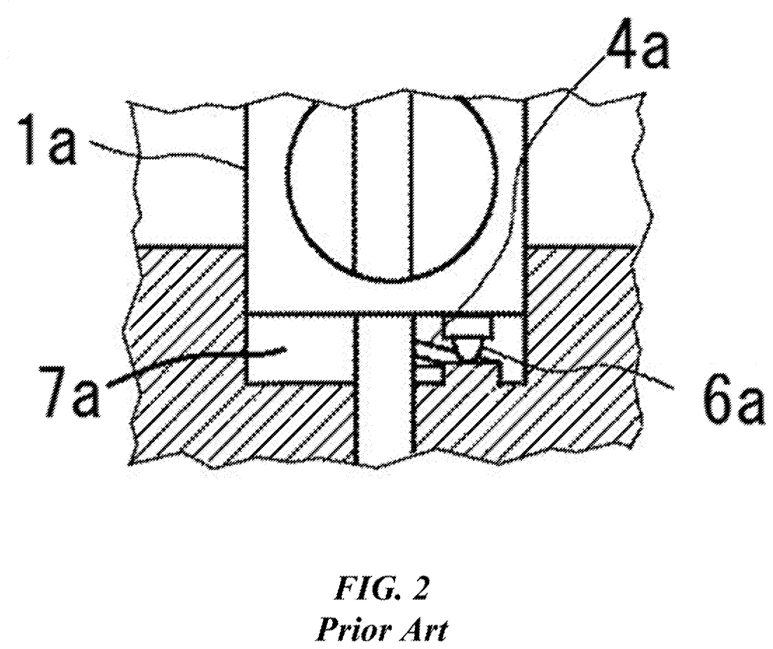

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

### Overview

The improved rotary type vaporizer of the present disclosure is designed to eliminate malfunctions caused by the cantilevered effect by using a columnar throttle valve, which can be arranged orthogonal to the intake passage of the vaporizer body. The columnar throttle valve includes a fuel nozzle, throttle hole, and a measuring needle. The fuel nozzle can be arranged on the central axis of the throttle valve into which the measuring needle can be inserted. The cam mechanism of the moving the throttle valve can be disposed along the valve axial direction. The valve shaft of the moving throttle valve can be throttled and can extend from the center of the upper surface of the throttle valve. The throttle valve rotates integrally with the valve shaft by rotating according to an operation and moves in the direction of the valve shaft via the cam mechanism to adjust the air and fuel flow rates. In some embodiments, the cam mechanism can be disposed outside the throttle valve.

A cam groove of the improved rotary type vaporizer (hereinafter “the rotary vaporizer”) can be formed by recessing the cam surface to become gradually deeper along the direction of rotation direction. The cam groove has a predetermined width in the central axis direction from the peripheral edge. The cam mechanism of the rotary vaporizer can be disposed in a direction orthogonal to the central axis of the throttle valve. It is composed of a columnar support pin that is provided on the main body and is inserted into the cam groove to abut the cam surface to support the throttle valve. The cam surface is disposed on a plane at a predetermined angle with respect to the bottom surface of the throttle valve, which is perpendicular to the throttle valve axis. The throttle valve is actuated when the body of the throttle valve is rotated, which causes the distal end of the support pin to be inserted into the cam groove and make contact with the cam surface. The distal end can be shaped at the same angle as the inclination of the cam surface. In other words, the distal end has a surface that is parallel to the surface of the cam surface. In this way, the distal end can glide on the cam surface as contact is made. The above support pin and cam groove construction is configured to direct the valve toward the center of the circle.

Further, the cam surface of the cam mechanism can be formed on the bottom surface of the throttle valve. The support pin can be disposed on the bottom surface of the cylindrical throttle valve chamber into which the throttle valve is rotatably inserted. The cam surface can be formed on the surface of the flange body provided at the shaft side end of the throttle valve facing the intake passage. In some embodiments, the support pin can be disposed on the vaporizer body.

The cam mechanism of the rotary vaporizer is configured so that the throttle valve is in the uppermost position when the throttle is fully opened, and the throttle valve is in the lowest position when the throttle is fully closed. In this way, the flow rate and fuel flow rate can be adjusted accurately with a simple operation. Additionally, this configuration eliminates the need to increase in size of the vaporizer body when the throttle is fully closed and when the bottom surface of the throttle valve is substantially brought into close contact with the bottom surface of the throttle valve chamber.

Further, in the rotary vaporizer, the cam groove can have a predetermined width in the central axis direction (from the outer peripheral side edge of the bottom surface of the throttle valve). The support pin of the cam mechanism is oriented orthogonal to the central axis of the throttle valve. In this way, the support pin can be inserted from the side, which helps make the assembly work relatively easy.

Furthermore, the rotary vaporizer described above is characterized in that the portion of the support pin in contact with the cam surface is a support roller that rotates following the rotation of the throttle valve. In this way, the wear at the contact part between the support pin and the throttle valve is minimized.

One of the objectives of the rotary vaporizer is to provide a cam mechanism for moving a throttle valve in the valve's axial direction without having to increase the size of the vaporizer body while also eliminating the cantilevered throttle valve issue.

### Improved Rotary Vaporizer

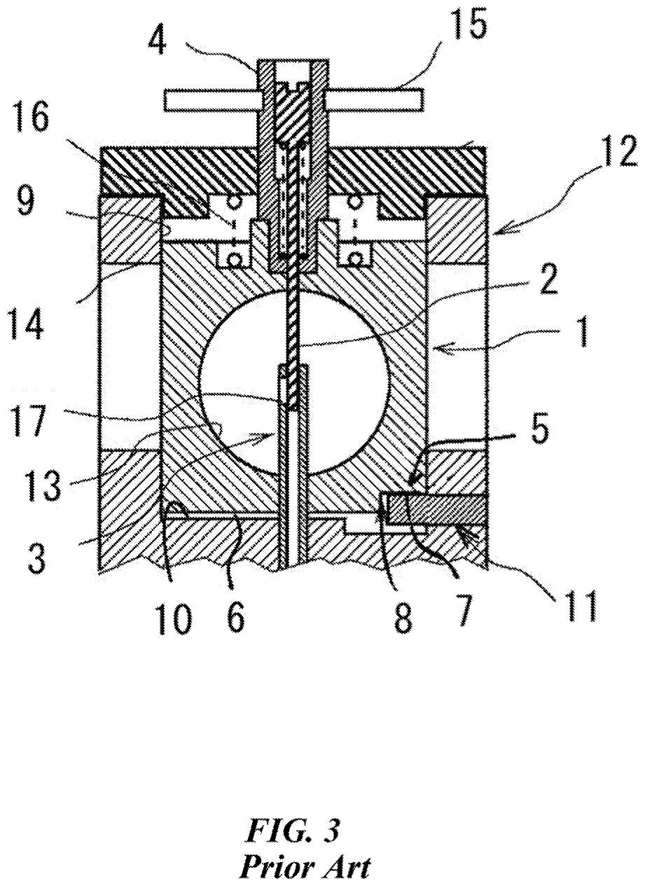

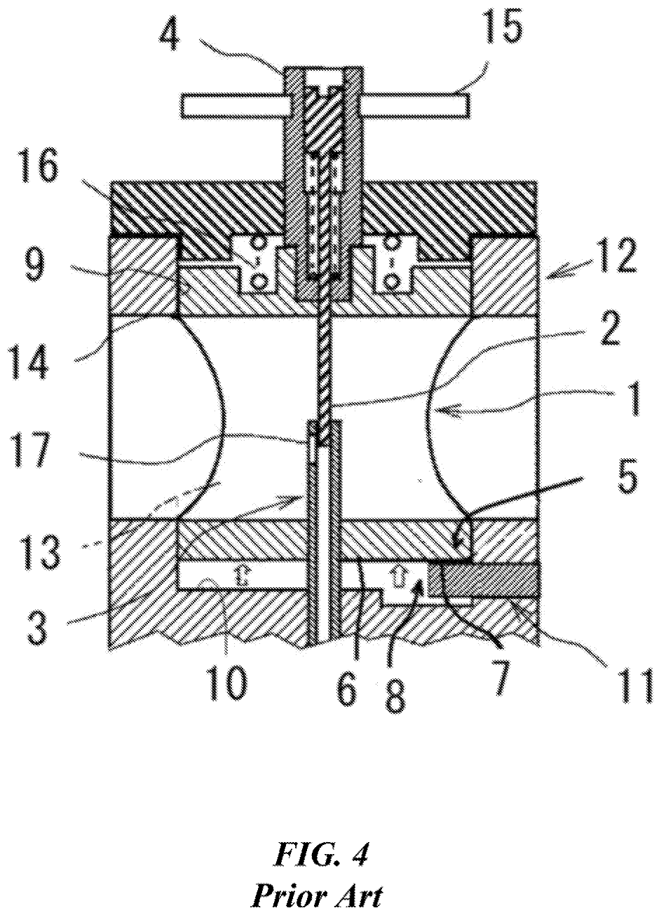

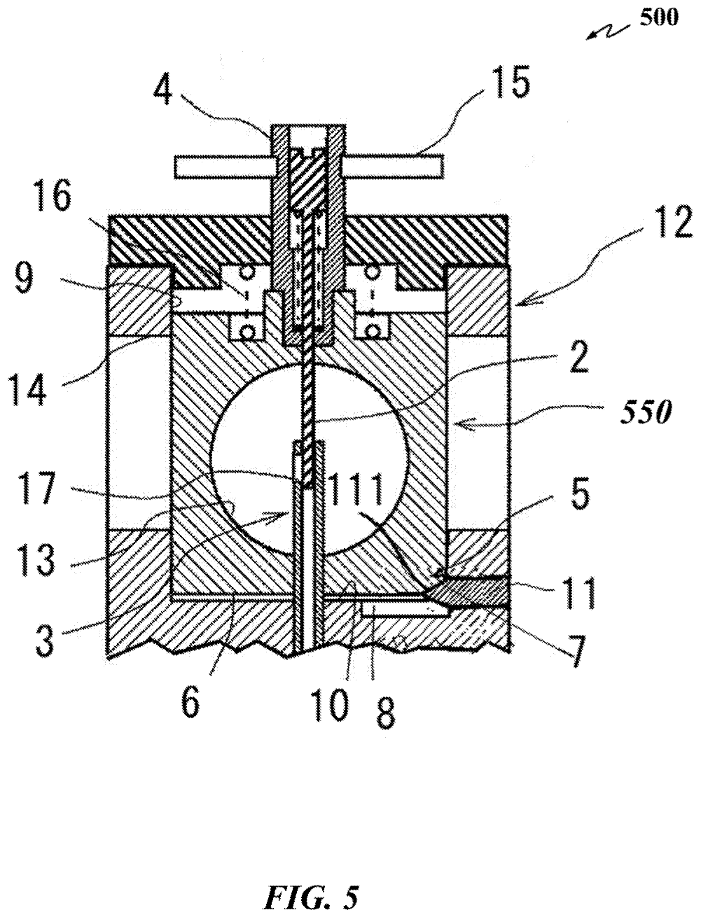

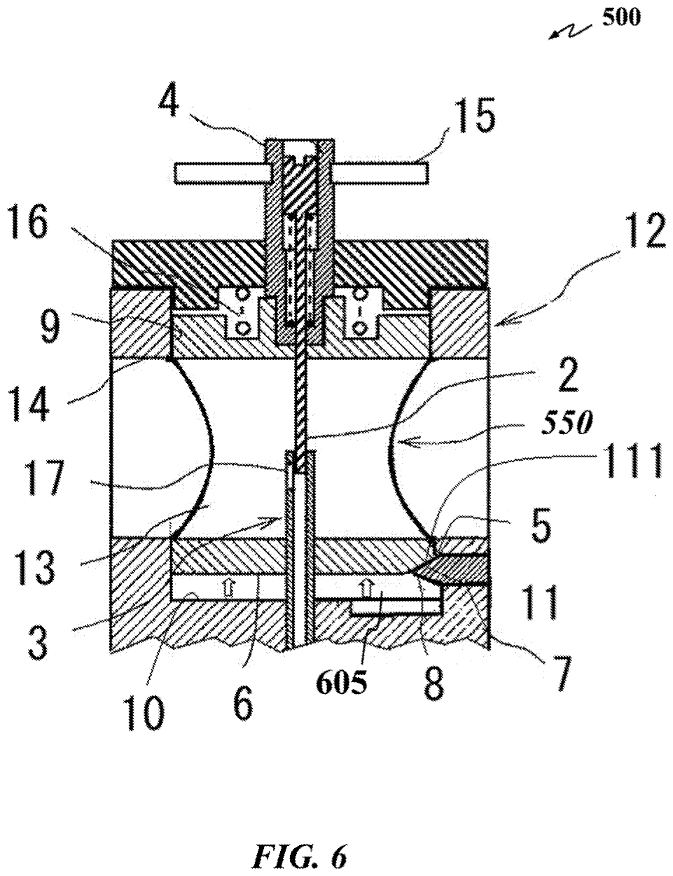

FIGS. 5 and 6 illustrate a rotary vaporizer 500 in accordance with some embodiments of the present disclosure. Although rotary vaporizer 500 shares similar components as those of the conventional rotary vaporizer shown in FIGS. 3 and 4 and that these components may have the same reference number, these reference numbers are only to aid the understanding and description of vaporizer 500. It should be noted that one or more components of vaporizer 500 can be different in one or more ways (e.g., mechanically, functionally) from components of the conventional rotary vaporizer (shown in FIGS. 3 and 4) having the same reference numbers. For example, cam surface 7 of vaporizer 500 is structurally and/or functionally different (see description below) than cam surface 7 of the conventional vaporizer shown in FIG. 3.

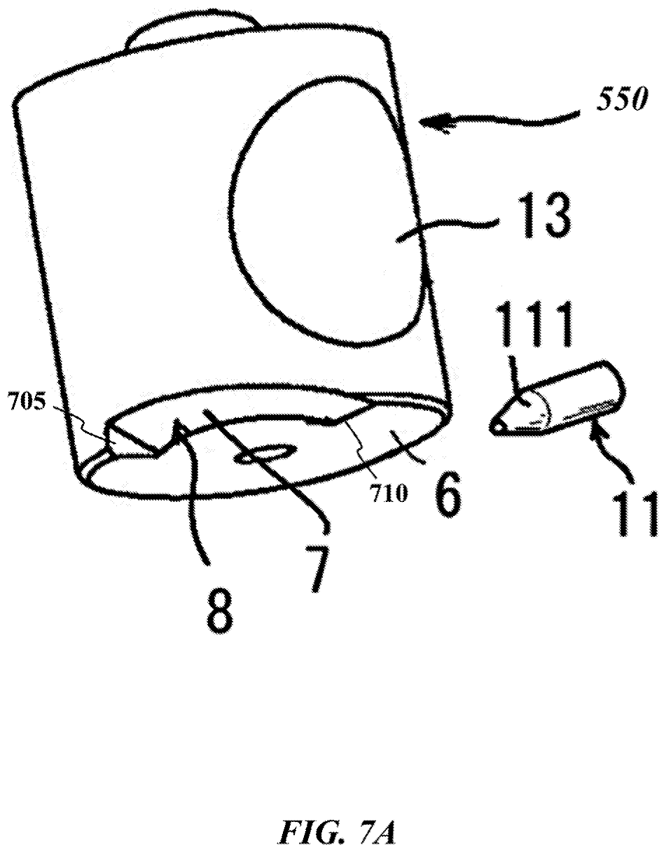

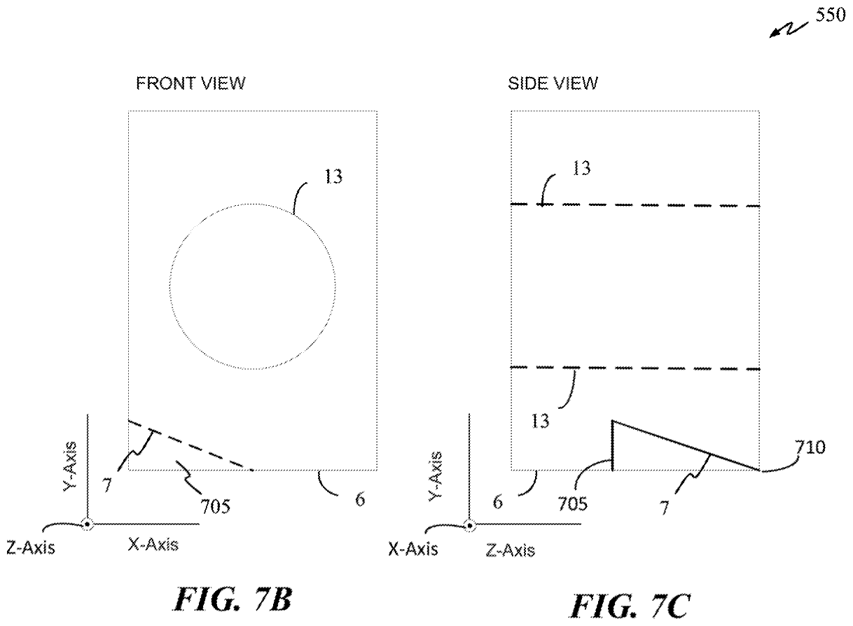

FIG. 5 is a partial vertical cross-sectional view of rotary vaporizer 500 and throttle valve 550 in accordance with some embodiments of the present disclosure. The cross-sectional view is centered on intake passage 14 portion when throttle valve 550 in a fully closed throttle state. FIG. 6 is a partial vertical cross-sectional view of rotary vaporizer 500 when throttle valve 550 is rotated to the fully open state. FIG. 7A illustrates a perspective view of throttle valve 550 in accordance with some embodiments of the present disclosure.

As a matter of review, in the conventional rotary vaporizer shown in FIG. 3, cam mechanism 5 includes cam surface 7 and cam groove 8. Cam surface 7 is parallel to the central axis of columnar support pin 11, which is also parallel to the bottom surface 6 of the throttle valve along the outer peripheral surface. In contrast, as shown in FIGS. 7A-7C, cam surface 7 of throttle valve 550 is not parallel to bottom surface 6 but is angled such that cam grove 8 gets progressively deeper toward distal end 705. Cam groove includes a proximal end 710 (proximal to the axis of throttle valve hole 13) and distal end 705. Proximal end 710 can be flushed with bottom surface 6. Alternatively, proximal end 710 can have depth but is shallower than distal end 705.

In some embodiments, cam surface 7 can be angled at an angle between 5-70 degrees with respect to bottom surface 6 (which is perpendicular to the axis of throttle valve 550. For example, cam surface 7 can be angled at a 45 degree with respect to bottom surface 6. Support pin 11 can also include an outer surface (not shown) configured to mate with cam surface 7. The outer surface of support pin 11 can be angled at the same angle of inclination of cam surface 7.

FIG. 7B illustrates a front view of throttle valve 550 where hole 13 runs in and out of the page. FIG. 7C illustrates a side view of throttle valve 550 where hole 13 runs parallel to the page. Cam surface 7 can be formed such that it is rotated about the z-axis shown in FIG. 7B at an angle between 5-70 degrees. Additionally, the plane of cam surface 7 can also be rotated about the x-axis and/or z-axis at an angle between 5-70 degrees. In some embodiments, cam surface 7 is rotated at an angle of 20 degrees about both the x and z axes. In FIG. 7B, the x-Axis runs parallel to bottom surface 6 and radially to hole 13. The z-axis runs parallel to the longitudinal axis of hole 13, which is out of the paper. As shown in FIG. 7C, the z-axis runs parallel to the longitudinal axis of hole 13, and the x-axis points out of the page. Although not clearly shown, cam surface 7 is rotated about x-axis and the z-axis—see the perspective view of throttle valve 550 in FIG. 7A.

As shown in FIG. 7A, cam groove 8 can be a slot formed into bottom surface 6 of throttle valve 550. The cross-section of cam groove 8 can be triangular as cam surface 7 is angled. Support pin 11 includes a conical (e.g., pointed) end 111, which is specifically shaped (and angled) to correspond with cam surface 7. In some embodiments, conical end 111 is parallel to cam surface 7. As throttle valve 550 rotates, surface cam 7 slide over the surface of conical end 111. Since cam surface 7 is angled such that groove 8 is deeper toward distal end 705 and shallower toward proximal end 710, throttle valve 550 is forced to move up or down—depending on the angle of rotation. When throttle valve 550 is rotated counter-clockwise, conical end 111 moves to the deeper portion of groove 8 and thus throttle valve 550 moves downward (toward support pin 11). When throttle valve 550 is rotated clockwise, conical end 111 moves to the shallower end of groove 8. This motion pushes throttle valve 550 upward—away from support pin 11. In some embodiments, support pin 11 of throttle valve 550 can be stationary. In other words, support pin 11 does not have to move in or out in order to actuate the throttle valve. In this way, it is possible to minimize the size of the vaporizer body 12,

Referring to FIG. 5, in a fully closed state, support pin 11 is at the distal end of groove 8 where groove 8 is at the deepest. In this state, bottom surface 6 of throttle valve 550 is near (or can be in contact) surface 10. In other words, bottom surface 6 moves toward surface 10 and away from throttle level 15. In the closed state, the volume of throttle valve chamber 9 is maximized as the body of throttle valve 550 moves toward support pin 11. Additionally, while in the fully closed state, intake passage 14 is blocked by the outer wall of throttle valve 550 as throttle valve hole 13 is not aligned with intake passage 14.

Referring to FIG. 6, to open the throttle valve, throttle lever 15 is rotated. The rotation of throttle lever 15 causes throttle valve 550 to rotate. As throttle valve 550 rotates from the closed position (FIG. 5), the contact position of the support pin 11 with respect to the cam surface 7 inclined along the rotation direction becomes shallower (almost the bottom position). In other words, as throttle valve 550 rotates, distal end 111 of support pin moves toward proximal end 710 of groove 8. This in effect pushes throttle valve 550 upward (away from support pin 11, which is stationary). As shown in FIG. 6, once throttle valve 550 is pushed upward, the volume of throttle valve chamber 9 is at its minimum.

When throttle valve 550 is pushed upward by support pin 11, spring 16 is compressed. In this way, the inner peripheral surface of the throttle valve hole 13 coincides with the inner peripheral surface of the intake passage 14. In other words, in an open state, throttle valve hole 13 is aligned with intake passage 14. This enables fluid to flow freely through and/or between intake passage 14 and throttle valve hole 13. Additionally, measuring needle 2 is lifted, and the fuel port 17 of the fuel nozzle 3 is also fully opened.

By rotating the throttle lever 15, throttle valve 550 moves in the direction of the valve axis direction while also rotating to a closed or opened position. The change in volume of throttle valve chamber 9 by the cam mechanism 5 enables the vaporizer to intake air. In this way, the amount of air and fuel flow can be adjusted. When the throttle is fully open, throttle valve 550 is in the uppermost position, and when the throttle valve is fully closed, the throttle valve 1 is in the lowest position. This makes it easy to perform accurate adjustments with simple operations.

In some embodiments, throttle valve chamber 605 is composed of cam surface 7 formed by cam groove 8 formed into surface 6 and a support pin 11, which is inserted between the bottom surface 10 of the throttle valve chamber 605 and cam surface 7. In this way, it is possible to minimize the increase in size of the vaporizer body 12 by avoiding the increase in the length in the valve axis direction.

Referring to FIG. 7A, a throttle wire (not shown) is pulled, throttle valve 550 is rotated counter-clockwise, which causes cam surface 7 to glide over distal surface 111 (of support pin 11) until the tip of support pin 11 reaches distal end 705. In some embodiments, distal surface 111 can have substantially the same angle as cam surface 7.

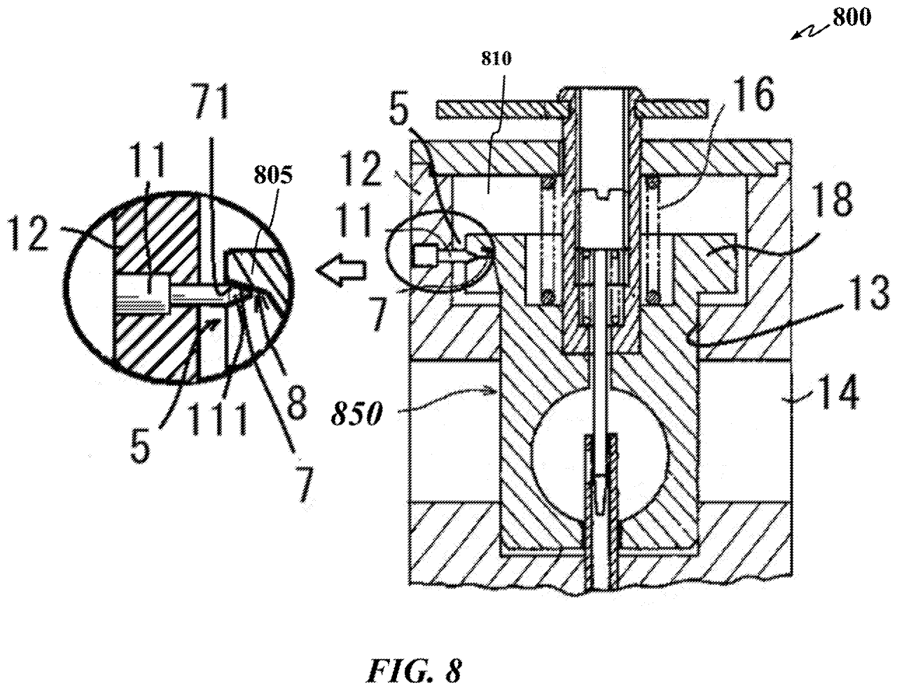

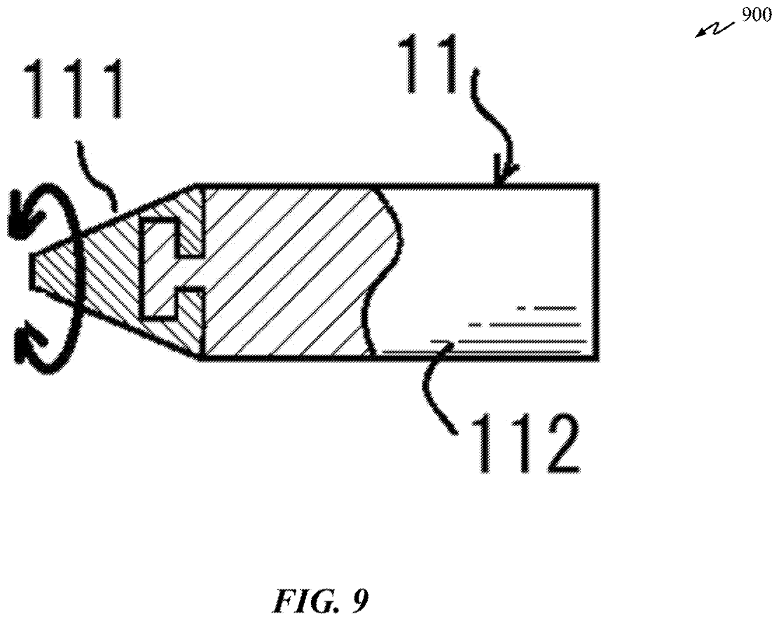

FIG. 8 illustrates a rotary vaporizer 800 in accordance with some embodiments of the present disclosure. Rotary vaporizer 800 can share one or more features of rotary vaporizer 500 as described above with respect to FIGS. 5, 6, and 7A-7C. As shown, rotary vaporizer 800 include cam mechanism 5 that is disposed at the top of rotary valve 850 instead of being disposed at the bottom. Rotary valve 850 includes lip 805 with cam surface 7 being disposed at the bottom of the lip. Cam surface 7 is similarly angled such that when rotary valve 850 is rotated, cam surface 7 would glide along the distal tip of support pin 11 to lift or lower rotary valve 850. In this way, the volume of chamber 810 would increase or decrease based which direction rotary valve 850 is actuated.

Stated differently, groove 8 is formed on flange body 18 of throttle valve 850. Flange body 18 is at the shaft side. Support pin 11 is part of cam mechanism 5, which is supported by vaporizer body 12. In this embodiment, the structure of the cam mechanism 5 is simple. That is throttle valve 850 can be easily assembled, disassembled, and reassembled. Additionally, the air flow rate and fuel flow rate are stable without the adhesion of dust and the like. It also has the advantage of being able to easily control.

As shown, rotary vaporizer 800 can also include valve spring 16, which can be configured to provide a pushing pressure on throttle valve 850 such that lip 805 is constantly pressed against support pin 11. Due to the angle of cam surface 7 and surface 111 of the distal tip of support pin being substantially the same, throttle valve 850 is able to actuate up and down without tilting. As such none of the outer wall of throttle valve 850 comes into contact with the inner wall of one of the throttle valve chambers, which can cause a malfunction such as an engine failure. In contrast, the throttle valve design of conventional rotary valves can cause the rotary valve to tilt during actuation. Other disadvantages of convention rotary valves are: require more operating force; throttle does not move linearly (along valve axis); take longer to return the throttle; and the throttle valve may stop halfway.

Further, since it is not necessary to consider the clearance between the throttle valve 1 and the throttle valve chamber 9, it becomes easy to control the dimensions at the time of manufacturing due to variations and combinations of individual component dimensions.

The tension (pushing pressure) of 16 and the cam angle of the inclined surface 111 of the support pin 11 (the inclined surface 71 from the central axis of the cam surface 7 toward the outer peripheral direction) are combined to always direct the throttle valve 1 toward the central axis. Therefore, the central axis of the throttle valve 1 is tilted as in the conventional case, and the throttle valve 1 (particularly the corner portion) does not come into contact with the inner wall of the throttle valve chamber 9 to cause a malfunction in operation. Increased throttle (not shown) operating force, throttle does not move linearly, it takes longer to return the throttle, and there is no possibility that the throttle will stop halfway.

As described above, with respect to the rotary type vaporizer, according to the present invention, it is possible to arrange a cam mechanism for moving the throttle valve in the valve axis direction without increasing the size of the vaporizer body, and in particular, the throttle. It is possible to solve the problem caused by the throttle valve becoming cantilevered when the wire is pulled.

FIG. 9 illustrates support pin 11 in accordance with some embodiments of the present disclosure. Support pin 11 includes a conical distal tip. The conical surface (111) can be angled at various angle. In some embodiments, conical surface 111 can be the same as the angle of inclination of cam surface 7 (not shown). The conical tip can be rotatably attached to the main body 112 of support pin 11. In this way, the contact friction between conical surface 111 and cam surface 7 can be reduced.

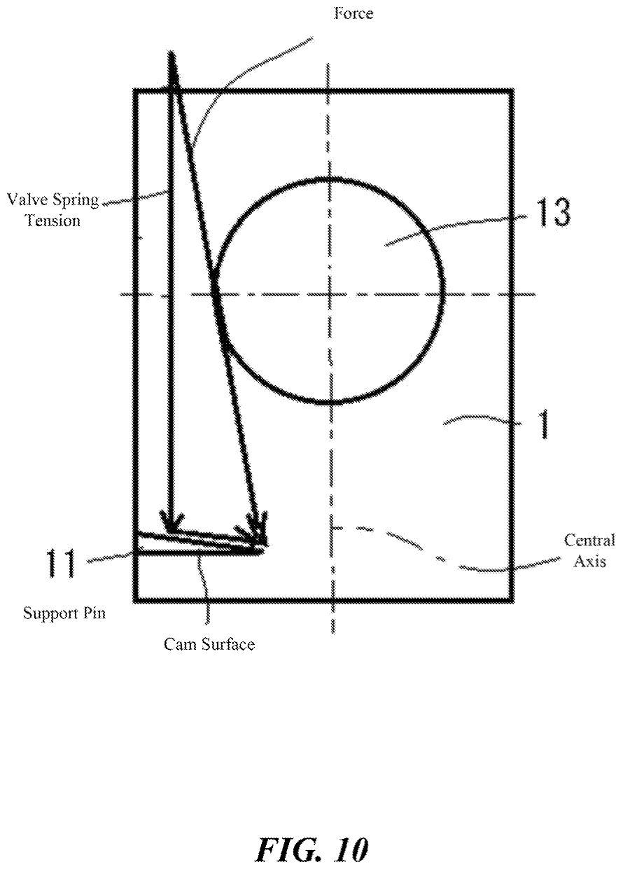

FIG. 10 is an explanatory view showing the principle of throttle valve vaporizer shown in FIG. 5 where the support pin is directed to the center during rotation of the throttle valve. Cam surface 7 of cam mechanism 5 can be formed on inclined surface 71 which is at a predetermined angle with respect to the central axis of throttle valve 850 toward the outer peripheral direction. The distal surface of support pin 11 can have the angle. As shown, when the throttle wire (not shown) is pulled, support pin 11 is pushed into the cam groove 8 by a valve spring (not shown) with a predetermined force, which has inclined surface 111 that has the same angle as the inclination of cam surface 7. In other words, inclined surface 111 is parallel with cam surface 7.

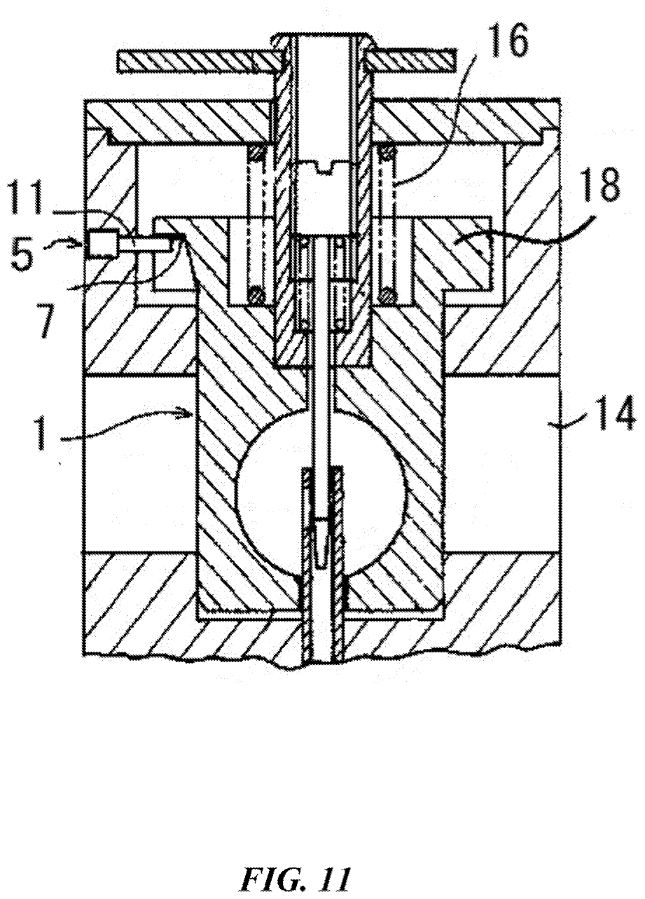

In contrast, in the conventional vaporizer shown in FIG. 11, support pin 111 has a straight distal end rather than an inclined surface that is also parallel to the corresponding surface on the flange. As shown in FIG. 11, both the support pin and the bottom surface of the flange are not angled as they are both horizontal.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The figures and the following description describe certain embodiments by way of illustration only. One skilled in the art will readily recognize from the following description that alternative embodiments of the structures and methods illustrated herein may be employed without departing from the principles described herein. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A columnar throttle valve arranged orthogonal to the intake passage of the carburetor body, the columnar throttle valve comprising:
a throttle hole; a measuring needle, and a fuel nozzle arranged on a central axis of the throttle valve and into which the measuring needle is inserted;
a valve shaft extending from a center of an upper surface of the throttle valve, the valve shaft is configured to rotate in response to a throttle operation; and
a cam mechanism for moving the throttle valve in an axial direction of the throttle valve, wherein the cam mechanism is configured to adjust the air flow rate and fuel flow rate by moving in the valve shaft and rotating the throttle valve.

2. The columnar throttle valve of claim 1, further comprising:
a cam groove formed on a bottom surface of the throttle valve such that the cam mechanism gradually becomes deeper along the rotation direction, wherein the cam groove comprises a predetermined width in the central axial direction from the outer peripheral side edge of the throttle valve,
wherein the cam mechanism comprises a support pin disposed on a body of vaporizer in a direction orthogonal to the central axis, wherein the support pin is inserted into the cam groove to abut the cam surface to support the throttle valve.

3. The columnar throttle valve of claim 1, wherein the cam groove comprises a cam surface formed on an inclined surface that descends at a predetermined angle toward the outer peripheral direction, and wherein the support pin comprises an angled surface at a same angle as the predetermined angle of the cam surface, wherein the throttle valve is configured to move toward the center of a circle when the valve is rotated.

4. The columnar throttle valve of claim 3, wherein the cam surface is formed on the bottom surface of the throttle valve, and the support pin is between the bottom surface of a throttle valve chamber and the cam surface.

5. The columnar throttle valve of claim 3, wherein the cam mechanism is formed on a surface of a flange body provided at the shaft side end portion of the throttle valve facing an intake passage.

6. The columnar throttle valve of claim 1, wherein the cam mechanism is configured such that the throttle valve is in the uppermost position when the throttle is fully opened and the throttle valve is in the lowest position when the throttle is fully closed.

7. The columnar throttle valve of claim 3, wherein the cam mechanism is supported with the support pin in contact with a cam surface portion that is the deepest part of the cam groove formed on a bottom surface of the throttle valve when the throttle valve is in the lowest position when the throttle is fully closed.

8. The columnar throttle valve of claim 7, wherein the bottom surface of the throttle valve can be substantially brought into close contact with the bottom surface of the throttle valve chamber.

9. A throttle valve vaporizer comprising:
a valve shaft;
a measuring needle disposed within the valve shaft;
a throttle valve having a lumen to receive the valve shaft; and
a support pin having a conical distal end having a predetermined angle, the conical distal end is configured to move axially move the throttle valve by gliding on an angled surface of the throttle valve, wherein the angled surface is parallel to a surface of the conical distal end.

10. The throttle valve of claim 9, wherein the conical distal end is rotatably coupled to a main body of the support pin.

11. The throttle valve of claim 9, wherein the angled surface of the throttle valve comprises a groove having a cam surface disposed on a bottom surface of the throttle valve.

12. The throttle valve of claim 9, wherein the angled surface of the throttle valve comprises a cam surface disposed on a flange of the throttle valve, wherein the flange is disposed on an upper surface of the throttle valve.

13. The throttle valve of claim 11, wherein the conical distal end is configured to be at the deepest part of the groove throttle valve when the throttle valve is in the lowest position.

14. The throttle valve of claim 11, wherein the conical distal end is configured to be at the shallowest part of the groove throttle valve when the throttle valve is in the highest position.
